(19) United States
(12) Patent Application Publication
(10) Pub. No.: US 2004/0142608 A1
(43) Pub. Date: Jul. 22, 2004

(54) Structure of connector terminal

(76) Inventor: Pei-Jung Wang, Tainan City (TW)

Correspondence Address: BIRCH STEWART KOLASCH & BIRCH, PO BOX 747, FALLS CHURCH, VA, 22040-0747, US

(21) Appl. No.: 10/705,015

(22) Filed: Nov. 12, 2003

(30) Foreign Application Priority Data
Jan. 22, 2003 (TW) 092201159

(51) Int. Cl. H01R 9/24

(52) U.S. Cl. 439/884

(57) ABSTRACT

A structure of a connector terminal is described. The structure of the connector terminal has a connecting end, a securing end and a plurality of neck sections disposed between the connecting end and the securing end such that a neck section can be cut to obtain a conductive terminal of desired length.

### BACKGROUND OF THE INVENTION

1. The Field of the Invention

The present invention relates to a structure of a connector terminal, and more particularly to a structure of a connector terminal having a connecting end, a securing end and a plurality of neck sections disposed between the connecting end and the securing end such that a neck section can be cut to obtain a conductive terminal of desired length.

2. Description of the Related Art

With rapid development of technology, the desktop and notebook computers have become popular and essential in our every day life. Different manufacturers have designed their products in different sizes and shapes, to fit the present trend of lightness, thinness, flatness, and smallness. However, the larger desktop and notebook computers are still be used by a majority of consumers. Therefore, various connectors for signal transmission in the computers are accordingly are available in various specification for appliance. The specification, usage range and assembly manner can directly affect the length of the conductive terminal. FIG. 6 shows an elevational view of a conventional conductive terminal A, which is a one-piece element; having a connecting end Al and a securing end A2. A specific mold is required manufacture a plurality of conductive terminal A with a certain length. Nevertheless, a variety of molds are required for making the conductive terminal A with different length to satisfy various specifications. Therefore, the cost for making the molds is substantially increased. And how to solve the above defects is the important issue for the manufacturer in the field.

### SUMMARY OF THE INVENTION

Accordingly, in the view of the foregoing, the present inventor makes a detailed study of related art to evaluate and consider, and uses years of accumulated experience in this field, and through several experiments, to create a new conductive terminal suitable for a variety of electrical connectors. The present invention provides an innovated, cost effective conductive terminal.

According to one aspect of the present invention, a plurality of neck sections are provides between the connecting end and the securing end of the conductive terminal such that the neck section can be cut using a suitable hand tool to obtain a conductive terminal of any desired length.

According to another aspect of the present invention, the securing end of the conductive terminal can be bent, and the horizontal part thereof can be welded to secure onto the circuit board by using the surface mounting technology (SMT).

### BRIEF DESCRIPTION OF THE DRAWING

For a more complete understanding of the present invention, reference will now be made to the following detailed description of preferred embodiments taken in conjunction with the accompanying drawings.

FIG. 1 is a side view of a structure of a conductive terminal of the present invention.

FIG. 2 is an elevational view I of the structure of a conductive terminal according to one preferred embodiment of the present invention.

FIG. 3 is an elevational view II of the structure of a conductive terminal according to one preferred embodiment of the present invention.

FIG. 4 is an elevational view III of the structure of a conductive terminal according to one preferred embodiment of the present invention.

FIG. 5 is a side view of the structure of a conductive terminal according to another preferred embodiment of the present invention.

FIG. 6 is an elevational view of a conventional conductive terminal.

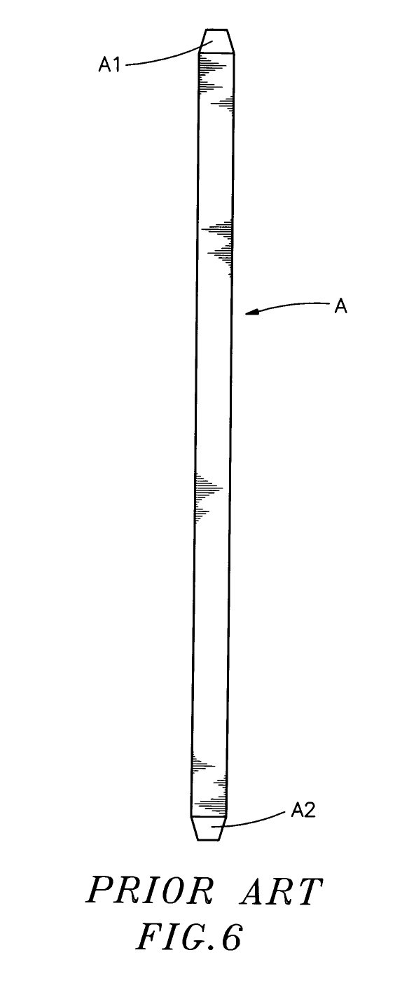

### DETAILED DESCRIPTION OF PREFERRED EMBODIMENTS

Reference will be made in detail to the preferred embodiments of the invention, examples of which are illustrated in the accompanying drawings. Wherever possible, the same reference numbers are used in the drawings and the description to refer to the same or like parts.

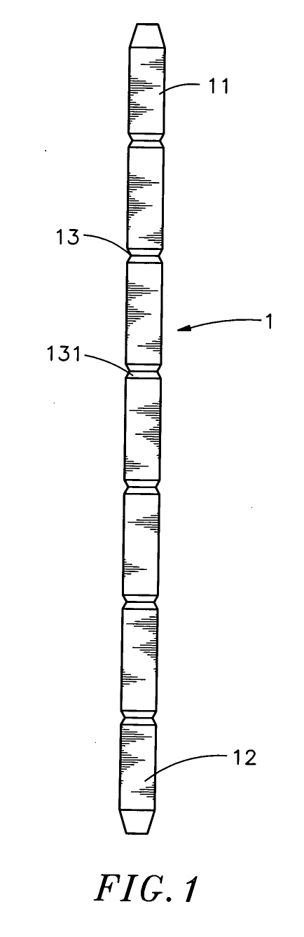

Referring to FIG. 1, the side view of a structure of a conductive terminal of the present invention is shown. The conductive terminal 1 of the present invention comprises a connecting end 11 at the distal end and a securing end 12 at the primal end thereof. A plurality of neck sections 13 is disposed between the above connecting end 11 and the securing end 12 of the conductive terminal 1, wherein each of the neck section 13 comprises two slope sections 131.

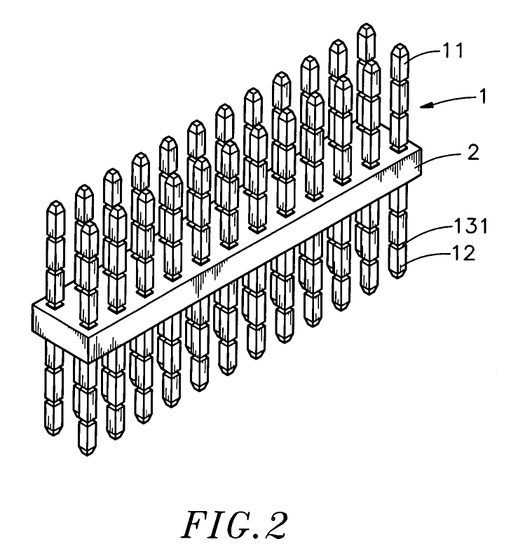

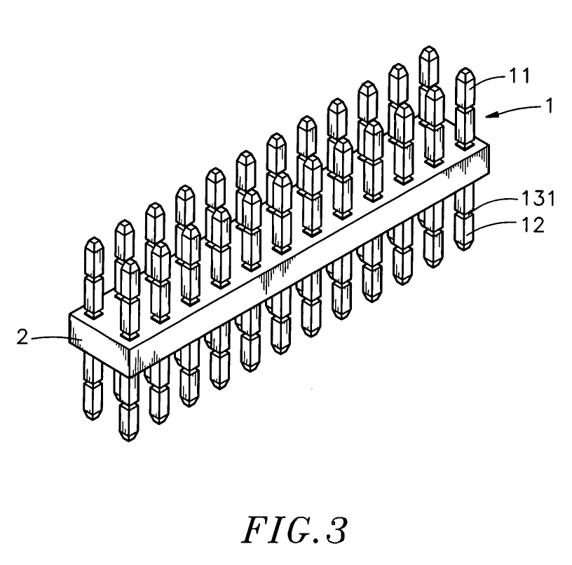

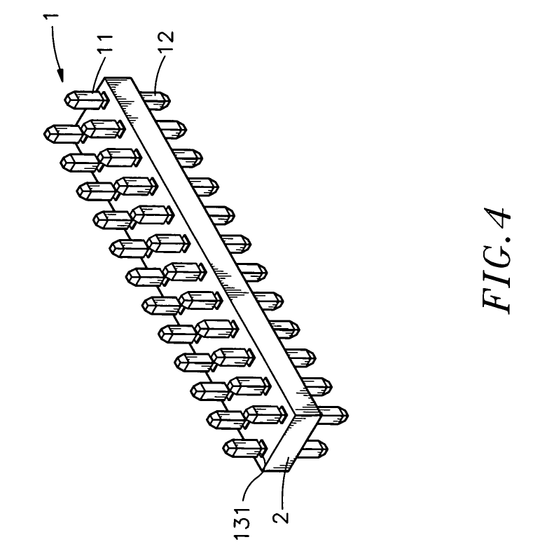

Referring to FIGS. 2, 3 and 4, the elevational views I, II and III of the structure of a conductive terminal according to one preferred embodiment of the present invention are shown. The conductive terminal 1 can be cut at the neck section 13 by using a hand tool for obtaining a conductive terminal of a desired length to fit into the terminal set 2. The conductive terminal 1 has two sloped side faces for the conductive terminal 1 to fit in or pass through easily. The conductive terminal 1 of the present invention has a plurality of neck sections 13 with slope sections 131 such that when the user cut the conductive terminal 1 at the neck section 13, the connecting end 11 and the securing end 12 still have a slope structure to facilitate easy fitting or pass through.

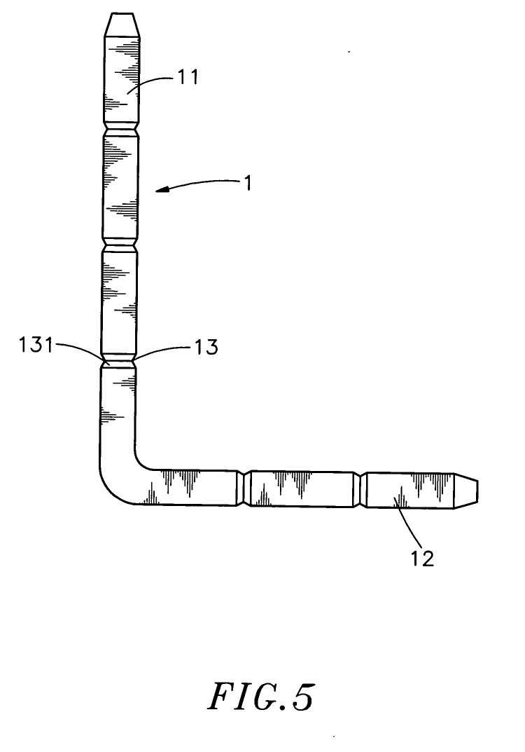

Further referring to FIG. 5, the side view of the structure of the conductive terminal according to another preferred embodiment of the present invention is shown. As shown in FIG. 5, the securing end 12 of the conductive terminal 1 can be bent, and a plurality of neck sections 13 is formed between the connecting end 11 and the securing end 12, thus the horizontal part of the securing end 12 of the conductive terminal 1 can be welded to secure onto the circuit board by using the surface mounting technology (SMT).

The above structure of the connector terminal is suitable for applying in various connectors, and has at least the following advantages.

The embodiment of the present invention requires only one set of mold for manufacturing, and by cutting at the neck section 13 of the conductive terminal 1, the conductive terminal 1 with desired lengths can be obtained.

The securing end 12 of the conductive terminal 1 can be bent, and the horizontal part thereof can be welded to secure onto the circuit board by using the surface mounting technology (SMT).

The conductive terminal 1 is made as one-piece structure, and therefore requires only one type of mold for manufacturing the conductive terminals. Thus, the manufacturing cost can be substantially reduced.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

What the invention claimed is:

1. A structure of a connector terminal suitable for an electrical connector, comprising:
a terminal set with a plurality of conductive terminals, each of said conductive terminals comprising:
a connecting end, at a distal end;
a securing end at a primal end; and
a plurality of neck sections between the connecting end and the securing end, wherein one of the neck sections at a prescribed location can be cut by using a tool to obtain a conductive terminal of a prescribed length.

2. The structure of connector terminal according to claim 1, wherein said neck section of said conductive terminal has two slope section.

3. The structure of connector terminal according to claim 1, wherein said securing end of said conductive terminal can be bent, and a horizontal portion thereof can be welded to secure said conductive terminal onto a circuit board by using a surface mounting technology.
